(19) United States
(12) Patent Application Publication
(10) Pub. No.: US 2015/0136369 A1
(43) Pub. Date: May 21, 2015

(54) EGR COOLER HEADER CASTING

(71) Applicants: Bashar Y. Melhem, Orland Park, IL (US); Luis Carlos Cattani, Aurora, IL (US); James P. Burke, Naperville, IL (US); Khawja Naveed, Bloomingdale, IL (US)

(72) Inventors: Bashar Y. Melhem, Orland Park, IL (US); Luis Carlos Cattani, Aurora, IL (US); James P. Burke, Naperville, IL (US); Khawja Naveed, Bloomingdale, IL (US)

(73) Assignee: International Engine intellectual Property Company LLC, Lisle, IL (US)

(21) Appl. No.: 14/406,454

(22) PCT Filed: Jun. 8, 2012
(86) PCT No.: PCT/US12/41628

§ 371 Date: Dec. 8, 2014

(51) Int. Cl. F28F 9/02; F02M 25/07

(52) U.S. Cl. CPC F28F 9/0219; F02M 25/0726
USPC 165/158

(57) ABSTRACT

A heat exchanger having a modified header design for absorbing high thermal loads, is described. The heat exchanger includes housing, core including a plurality of tubes providing flow passages within the housing and header plate positioned at an end of the housing and connected to the core. The header plate and flow passages join forming a thermal deflecting junction. In addition, a header for use with an exhaust gas heat exchanger, is disclosed. The header includes a header plate having a planer base wall and a flange extending from the base wall for receiving an end of at least one exhaust gas tube, a heat deflecting junction where the header plate meets the end of the tube. The header also includes a joint formed from the flange connecting to the tube, and positioned a suitable distance from the heat deflecting junction.

### TECHNICAL FIELD

The present device relates to a heat exchanger for use in internal combustion engines. Particularly, the present device relates to an exhaust gas recirculation (EGR) cooler having modified header design for absorbing higher thermal loads resulting from increased thermal load through the EGR cooler in order to increase the reduction of NOₓ in the exhaust stream.

### BACKGROUND

Diesel engines are efficient, durable and economical. In the past 20 years, governments, such as the United States and the European Union, have proposed stricter diesel exhaust emission regulations. These environmental regulations require diesel engines to meet increasing stricter pollution emission standards. Typically, to meet such regulations and standards, diesel engine systems require equipment additions and modifications.

For example, a lean burning engine provides improved fuel efficiency by operating with an amount of oxygen in excess of the amount necessary for complete combustion of the fuel. Such engines are said to run “lean” or on a “lean mixture.” However, the increase in fuel efficiency is offset by the creation of undesirable pollution emissions in the form of nitrogen oxides (NOₓ). Nitrogen oxide emissions are regulated through regular emission testing requirements.

Many internal combustion engines use an exhaust gas recirculation (EGR) system to reduce the production of NOₓ during the combustion process in the cylinders. EGR systems typically divert a portion of the exhaust gases exiting the cylinders for mixing with intake air. The exhaust gas generally lowers the combustion temperature of the fuel below the temperature where nitrogen combines with oxygen to form NOₓ. EGR systems have an EGR cooler or heat exchanger that reduces the temperature of the exhaust gases. Generally, more exhaust gas can be mixed with the intake air when the exhaust gas temperature is lower. Additional exhaust gases in the intake air may further reduce the amount of NOₓ produced by the engine.

EGR coolers typically use coolant from the engine's cooling system to reduce the temperature of the exhaust gases. The coolant may be water, an antifreeze fluid such as ethylene glycol, a combination thereof, or the like. The EGR cooler is connected to another engine component in series so that the same coolant flows through the other component and then the EGR cooler in sequence. The EGR cooler includes a plurality of internal tubes or conduit providing a pathway for flow of exhaust gases through the cooler. As the exhaust gases flow through the tubes, excess heat is released into circulating coolant thereby reducing the temperature of the exhaust gases and the formation of NOₓ.

With more stringent emission regulations comes the need to increase EGR flow rates. Increasing flow rates challenge the robustness of the EGR cooler to absorb higher thermal loads and reduces the life of the EGR cooler. However, increased thermal loads may cause the EGR header to deform, which in turn, may weaken the tube to header junction and shorten the life of the EGR cooler. For example, a typical heat exchanger includes a series of tubes supported by two headers. One type of conventional header is a flat header. When these flat headers are joined to a respective tube, for example, by brazing, the joint between the header and the tube lies in a flat plane. These types of header/tube combinations are prone to failure because of the stress concentrations that occur along the header/tube joint. These stresses are typically attributable to the thermal loading (i.e., stresses induced by the rise and fall of the temperature of the heat exchange components) on the header and tubes during the operation of the engine.

In an effort to counteract the thermal increase, a modified header is proposed to deflect and/or absorb thermal loads before reaching the sensitive tube-to-header junction. The present disclosure provides a cast header plate, which when joined to the entrance of an exhaust tube, creates a rounded or curved entrance rather than a perpendicular or 90° entrance for a standard flat header plate. The curved or concave junction is formed where the tubes meet the header creating a rounded entrance for the exhaust gas passage, where the temperature gradient is highest. This modified junction deflects some of the heat at the entrance. Additionally, the design of the cast header plate naturally moves the brazed joint (where the header plate meets the exhaust gas tube) back from the high temperature gradient area, such that the area is less susceptible to the high temperature exhaust gases, which may cause braze joint imperfections. Thus, the modifications are designed to deflect and/or absorb the thermal loads away from the tube-to-header junction.

The present disclosure provides an EGR cooler with a modified tube-to-header design to counteract any increase in thermal loads resulting from increases in exhaust flow through the EGR cooler. The modified header and tube-to-header junction design provides a cost-effective solution because it does not require a change in design or major modification to the EGR cooler itself Furthermore, the modified header design results in an increase of the thermal life of the EGR cooler.

### SUMMARY

There is disclosed herein a device, which avoids the disadvantages of prior devices while affording additional operating advantages.

Generally speaking, a heat exchanger, which may include an EGR cooler, having a modified header design for absorbing high thermal loads and decreasing the thermal stress on the exhaust tube-to-header junction, is described and claimed.

In an embodiment, a heat exchanger for use in reducing the production of NOₓ in an exhaust stream, is disclosed. The heat exchanger comprises a housing having an interior space, a core within the interior space of the housing, the core comprising a plurality of tubes providing flow passages, and, a header plate positioned at an end of the housing and connected to the core, wherein the header plate and an entrance of the flow passages form a thermal deflecting junction.

In an embodiment, the header plate further includes a flange extending from the base wall toward the core, the flange surrounding the exterior cross section of the tubes received in the openings.

In yet another embodiment, a brazed joint is formed where the flange surrounds the tubes, the brazed joint being positioned a suitable distance away from the thermal deflecting junction.

In an embodiment, a header for use with an exhaust gas heat exchanger, is disclosed. The header comprises a header plate comprising a planer base wall and a plurality of tube receiving openings in the base wall, a flange extending from the base wall for receiving an end of at least one tube for receiving exhaust gas within the heat exchanger, a heat deflecting junction where the header plate meets the end of the tube and, a joint formed from the flange connecting to the tube, the joint being positioned a substantial distance from the heat deflecting junction.

### BRIEF DESCRIPTION OF THE DRAWINGS

FIG. 1a is an embodiment of a prior art header;

FIG. 1b is close-up of the prior art header of FIG. 1;

FIG. 2 is a perspective view of an EGR cooler with an embodiment of the modified header design of the present disclosure;

FIG. 3 is sectional view of an embodiment of the header design of the present disclosure showing the modified tube-to-header connection;

FIG. 4 is a sectional view of an embodiment of the modified header design; and,

FIG. 5 is a sectional view of yet another embodiment of the modified header design of the present disclosure.

### DETAILED DESCRIPTION

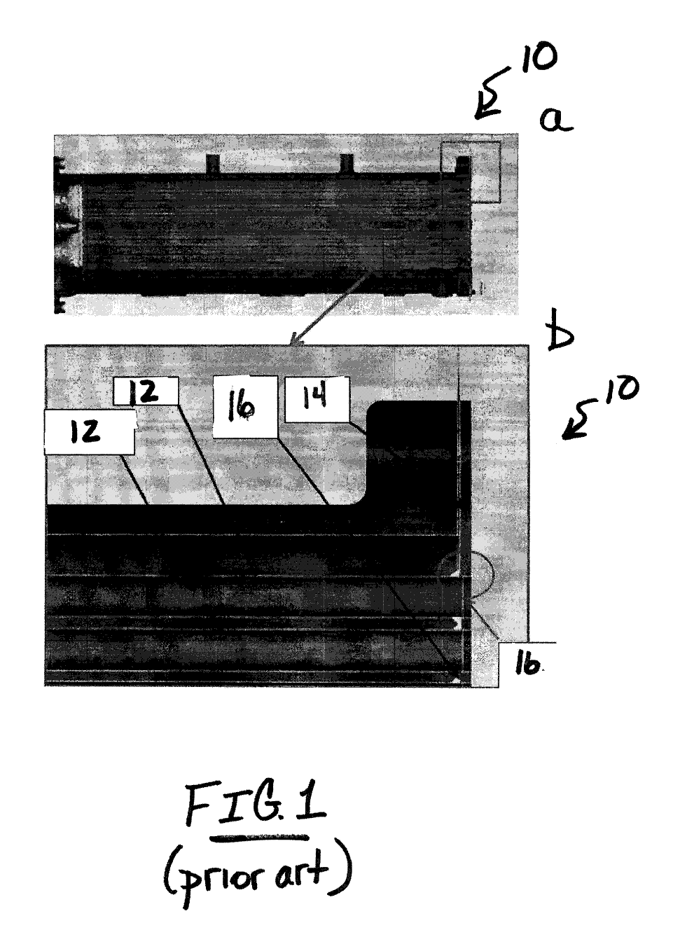

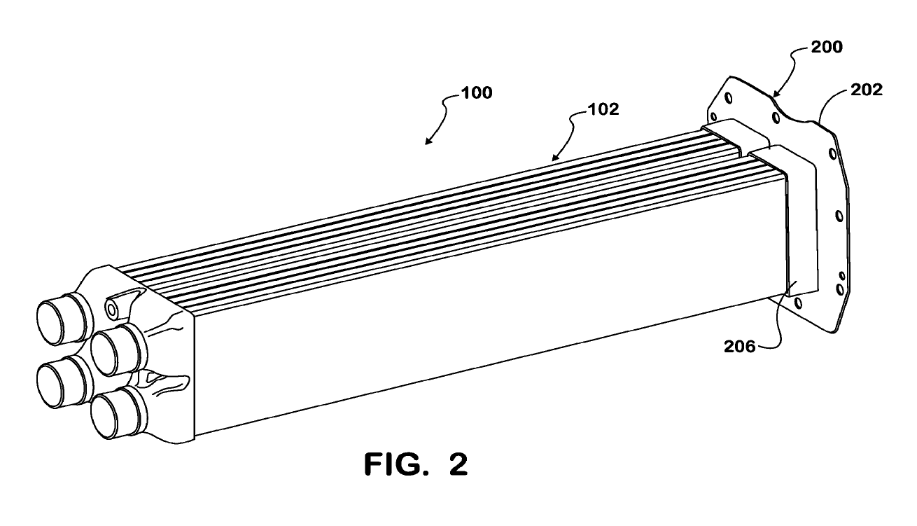

Referring to FIG. 1, there is illustrated a prior heat exchanger, generally designated 10, while FIGS. 2-5 illustrate a heat exchanger with a modified header design of the present disclosure, generally designated as 100. The heat exchanger may be an EGR cooler used in a vehicle to reduce the NOₓ in the exhaust stream. As generally known, hot exhaust flow enters into the heat exchanger from the exhaust manifold (not shown) near the turbocharger (not shown) of an engine (not shown). By circulating a coolant, or cooling fluid through the heat exchanger 10,100 through a series of passageways, and over a plurality of baffle (not shown)s, the hot exhaust gases (flowing through a passageway separate from the coolant) are cooled to a temperature that will not adversely impact combustion efficiency. The cooled gases are returned to the intake manifold (not shown) through an EGR valve (not shown), which opens and closes based on operating conditions. Reducing the temperature of the exhaust gases diminishes the amount of NOₓ produced in the exhaust stream.

FIGS. 1a and 1b illustrate typical prior art header designs. In the prior art design, the exhaust flow tube 12 is perpendicular with the header plate 14. The tube 12 and header plate 14 are connected by a brazed joint 16 formed by a braze filler metal. In this design, the tube-to-header joint 16 is generally subject to high heat as the exhaust enters the tube. The increase in thermal load on the joint can lead to failure of the joint due to high heat stress and reduce the life of the heat exchanger.

FIGS. 2-5 illustrate a heat exchanger 100 with a modified header 200, which is the subject of the present disclosure. Heat exchangers and EGR coolers are typically comprised of a casing or housing 102 for receiving a core 104. The housing 102 also includes an inlet (not shown) for receiving a cooling fluid into the interior space, and outlet (not shown) for releasing the cooling fluid from the interior space. The housing 102 can have any suitable shape depending on vehicle or other mechanical requirements, but is typically elongated, having a length sufficient for adequate coolant flow and heat dissipation from the exhaust stream.

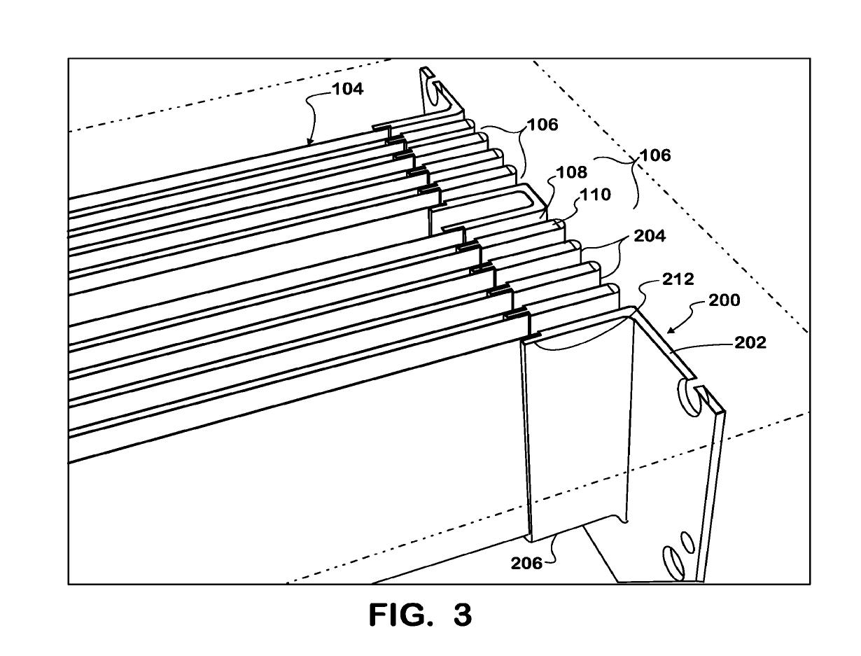

As shown in FIG. 3, which is a cross-section of the heat exchanger with the modified header of FIG. 2, the core 104 is made up of a plurality of passageways 106. The plurality of passageways further includes separate passageways for exhaust gases and coolant fluid. Specifically, the core includes a first flow passage 108, which is a plurality of tubes or conduits for receiving exhaust gas. The core 104 also includes a second flow passage 110 comprising a plurality of tubes for receiving and circulating a cooling fluid. The second flow passage 110 may include a series of baffles (not shown), which direct the flow of coolant through the passage. It should be understood that the first flow passage and second flow passage can include a variety of configurations (for example, straight, curved or angled) and arrangements to one another within the housing, depending on the ultimate design of the heat exchanger and the cooling requirements of the system in which it is being used.

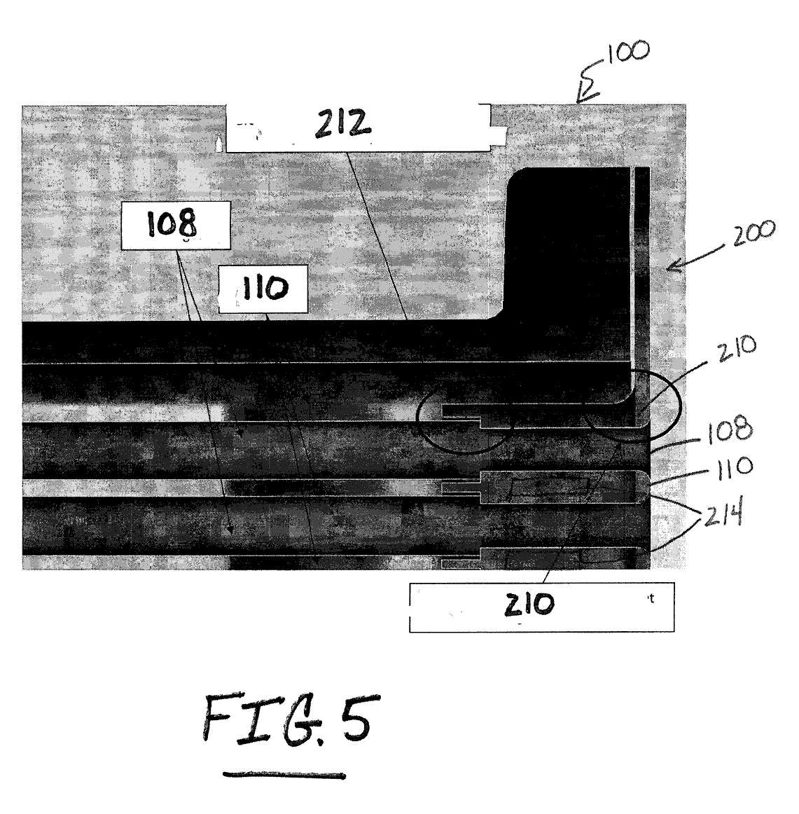

As mentioned, the typical heat exchanger 10 (FIG. 1) includes at least one header plate 14, which is attached to the tubes 12 by a brazed joint 16. Because the exhaust entering the heat exchanger is at its highest temperature, the tube-to-header joint 16 can become weakened with excess thermal load if the header deforms due to its configuration, resulting in a shorter operational life of the heat exchanger. In an effort to avoid possible thermal deformation and a weakened tube-to-header joint, a heat exchanger 100 having a modified header plate design 200, is described. FIGS. 2-4 illustrate one embodiment of the modified header plate 100, while FIG. 5 represents another possible embodiment of the modified header.

As shown in FIG. 2, the header plate 200 is formed as a cast unit so that it fits in a sleeve-like manner over an end of the housing 102 of the heat exchanger 100. Specifically, the header plate 200 includes a planer base wall 202 and a plurality of tube receiving openings 204 in the base wall (FIG. 3). The header plate 200 further includes a flange 206 extending from the base wall toward the core 102. The flange 206 surrounds the exterior cross section of the tubes that are received in the openings.

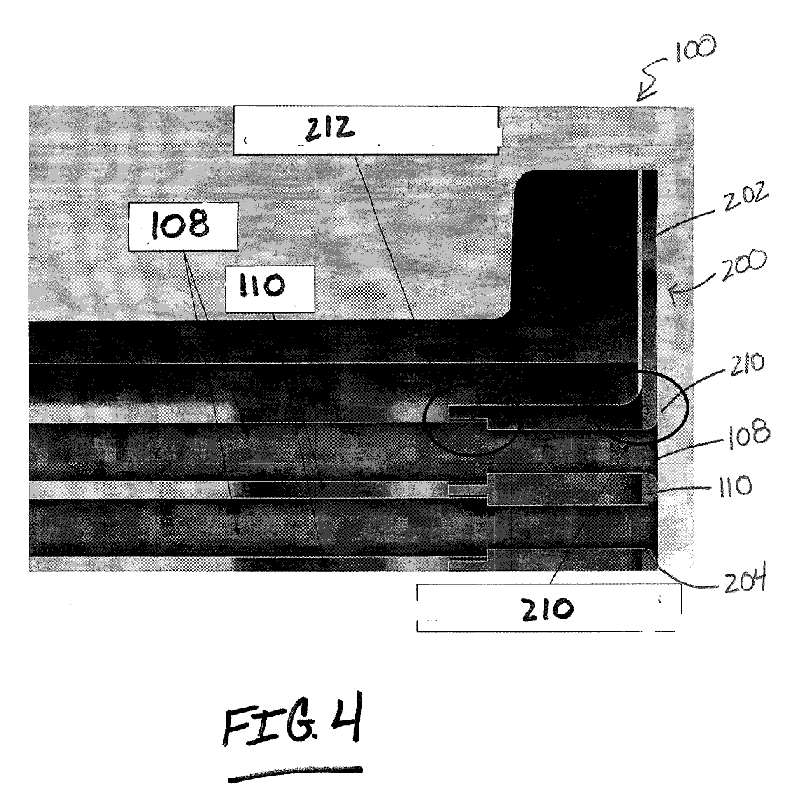

As illustrated in FIG. 4, the modified header plate 200 includes a fillet 210, which is a concave junction formed where the surfaces of the tubes and header plate meet. The fillet 210 provides a curved or rounded entrance, rather than the perpendicular or 90° tube-to-header joint found in a typical flat header plate, shown in FIG. 1b. The entrance to the exhaust tube is subject to the highest exhaust gas-to-coolant temperature gradient and hence the highest thermal strain. The fillet 210, with its curved configuration provides a larger surface area, which dissipates some of the heat of the entering exhaust gases and reduces the thermal strain due to lower gradient and improved geometry. Optionally, the fillet can have a bell-shaped configuration, with the widest portion facing outward for maximum contact with the incoming hot exhaust gases.

Construction of a typical heat exchanger 10 includes forming a perpendicular joint 16 where the tube meets the header plate, as shown in FIG. 1b. The joint 16 is filled with a braze filler metal. As mention, because of its configuration, the brazed joint 16 is subject to exhaust gases at the highest temperature entering the exhaust tubes 12. In the present modified header 200, however, the configuration of the flange 206 moves the tube-to-header joint 212 back and away from the entrance of the exhaust tube 108. FIG. 4 illustrates that the brazed joint 212 of the modified design is set back a sufficient distance from the entrance of the tube. In this manner, the brazed joint 212 is less susceptible to thermal strain from the high temperature exhaust entering the tube. Maintaining the brazed joint, and thus the connection of the header plate to the tubes may extend the overall useful life of the heat exchanger.

FIG. 5 illustrates yet another embodiment of the modified header 200. In this particular embodiment, additional coolant passages 214 may be drilled into the header plate. The coolant passage 214, which may be one to several depending on design requirements, would aid in increasing the heat exchange rate at the entrance to the tubes, and further reduce the stress on the brazed joint 212.

What is claimed is:

1. A heat exchanger for use in reducing the production of NOₓ in an exhaust stream, the heat exchanger comprising:
a housing having an interior space;
a core within the interior space of the housing, the core comprising a plurality of tubes providing flow passages; and,
a header plate positioned at an end of the housing and connected to the core, wherein the header plate and an entrance of the flow passages form a thermal deflecting junction.

2. The heat exchanger of claim 1, wherein the tubes comprise a first flow passage and a second flow passage.

3. The heat exchanger of claim 2, wherein the first flow passage receives exhaust gas.

4. The heat exchanger of claim 2, wherein the second flow passage receives a coolant.

5. The heat exchanger of claim 1, wherein the header plate comprises a planer base wall and a plurality of tube receiving openings in the base wall.

6. The heat exchange of claim 5, wherein the header plate further includes a flange extending from the base wall toward the core, the flange surrounding an exterior cross section of the tubes received in the openings.

7. The heat exchanger of claim 6, wherein a brazed joint is formed where the flange surrounds the tubes.

8. The heat exchanger of claim 7, wherein the brazed joint is located a suitable distance from the thermal deflecting junction.

9. The heat exchanger of claim 1, wherein the thermal deflecting junction forms where the header plate and the entrance of the flow passages meet.

10. The heat exchanger of claim 9, wherein the thermal deflecting junction further comprises a rounded entrance at the header and flow passages.

11. A header for use with an exhaust gas heat exchanger, the header comprising:
a header plate comprising a planer base wall and a plurality of tube-receiving openings in the base wall;
a flange extending from the base wall for receiving an end of at least one tube for receiving exhaust gas within the heat exchanger;
a heat deflecting junction formed where the header plate meets the end of the tube; and,
a joint formed from the flange connecting to an exhaust tube, the joint being positioned a suitable distance from the heat deflecting junction.

12. The header of claim 11, wherein the flange surrounds an exterior cross section of the tubes received in the openings.

13. The header of claim 11, wherein the heat deflecting junction forms a rounded entrance for receiving exhaust gas.

14. The header of claim 11, wherein the joint is a brazed joint.
